(19) United States
(12) Patent Application Publication
(10) Pub. No.: US 2024/0121704 A1
(43) Pub. Date: Apr. 11, 2024

(54) LOCATION MANAGEMENT IN A MULTI-WIRELESS NETWORK ENVIRONMENT

(71) Applicant: CHARTER COMMUNICATIONS OPERATING, LLC, ST. LOUIS, MO (US)

(72) Inventor: Amitav Mukherjee, Elk Grove, CA (US)

(73) Assignee: CHARTER COMMUNICATIONS OPERATING, LLC, ST. LOUIS, MO (US)

(21) Appl. No.: 17/961,835

(22) Filed: Oct. 7, 2022

(51) Int. Cl. H04W 48/16; H04W 64/00; H04W 76/15; H04W 76/19

(52) U.S. Cl. CPC H04W 48/16; H04W 64/003; H04W 76/15; H04W 76/19

(57) ABSTRACT

According to one configuration, a multi-wireless communication system includes communication management hardware disposed in a first wireless network. The communication management hardware provides a mobile communication device first wireless access via a first wireless network in accordance with first subscriber identity information. The communication management hardware detects that the mobile communication device has second wireless access to a second wireless network in accordance with second subscriber identity information. To determine a location of the mobile communication device, the communication management hardware implements a location management function in the first wireless network. The location management function can be configured to produce the location information to include timing information associated with wireless communication between the second wireless network and the mobile communication device. The communication management hardware uses the timing information to determine the location of the mobile communication device.

### BACKGROUND

One type of 5G network is a so-called hybrid mobile network with dual-SIM dual-standby (DSDS) UEs. In such a network, UEs (user equipment) can connect to the network of operator A for a first set of services, and to the network of operator B for a second set of services. A DSDS UE does not simultaneously connect to both networks and connecting to Operator B may be prioritized while tuning away periodically to Operator A to check for paging messages. However, in general, simultaneous connectivity by a UE to multiple networks is possible in a hybrid deployment.

Since a single operator does not provide a full suite of services, it may deploy a 5G core network with limited functionalities. For example, Operator B (data services) can deploy only the 5G core network functions needed for authentication, session management and user plane traffic handling, while other network functions such as location management are absent.

UE location management and positioning is a desirable function in 5G networks. In the 5G System (5GS), the location management function (LMF) is responsible for UE location estimation by the network.

### BRIEF DESCRIPTION OF EMBODIMENTS

There are deficiencies associated with conventional techniques of providing wireless connectivity. For example, in a 5G deployment with multi-network connectivity, a network without LMF (Location Management Function) in the core cannot estimate UE positioning even if the UE prioritizes connecting to its access network. If the UE only intermittently connects to the network or has poor signal quality to the network(s) with full-fledged positioning and LMF capabilities, then the UE location accuracy at the network will be poor. An example scenario includes two networks such as a first wireless network controlled by a first operator (first wireless network service provider), and a second wireless network controlled by a second operator (second wireless network service provider). When the UE is connected to the network of operator B, it is not feasible to use radio measurements on the network of operator B for UE location detection since operator B does not have its own LMF.

Certain embodiments herein include augmenting UE location management in multi-network scenarios where one network lacks UE location management capabilities. Also noted, the greater the variety of RAN position measurements (such as from two different network instead of just one network), the higher the UE positioning accuracy.

According to embodiments herein, a multi-wireless communication system includes communication management hardware disposed in a first wireless network. The communication management hardware provides a mobile communication device first wireless access via a first wireless network in accordance with first subscriber identity information. The communication management hardware detects that the mobile communication device has second wireless access to a second wireless network in accordance with second subscriber identity information. To determine a location of the mobile communication device, the communication management hardware implements a location management function in the first wireless network. The location management function can be configured to produce the location information to include timing information associated with wireless communication between the second wireless network and the mobile communication device. The communication management hardware in the first wireless network uses resources in the second wireless network to obtain timing information and determine the location of the mobile communication device.

In further example embodiments, the communication management hardware implements the location management function in the first wireless network to monitor the location of the mobile communication device based on a combination of the location information received from the second wireless network and supplemental location information received from the first wireless network. In one embodiment, the location management function includes multiple wireless base stations in the second wireless network communicating with the mobile communication device. The wireless base stations or other suitable entity generate, for each wireless base station, timing information that tracks a time it takes a respective wireless signal to travel from the respective wireless base station to the mobile communication device. The communication management hardware receives the timing information and implements trilateration or other suitable technique to determine the location of the mobile communication device. Thus, in one embodiment, the location information from the second wireless network includes location measurements (such as timing information) obtained from a communication management resource operating in the second network.

In still further example embodiments, the communication management hardware accesses a so-called network exposure function (NEF) to determine a network address of a communication management resource (such as an AMF or Access and Mobility Management Function) in the second wireless network to control operation of one or more wireless base stations in the second wireless network. As previously discussed, the second wireless network collects the timing information and forwards it to the first wireless network over a communication link. In one embodiment, the communication management hardware establishes the communication link between the first wireless network and the second wireless network via an inter-network communication link such as an NL1 inter-network link.

Further embodiments herein include, via the communication management hardware or other suitable one or more entities, establishing a first inter-network link between the first wireless network and the second wireless network; establishing a second inter-network link between the first wireless network and the second wireless network; and communicating location information from the first wireless network over the first inter-network link to a communication management resource in the second wireless network. The communication management resource in the second wireless network conveys the location information over the second inter-network link to a gateway management resource of the first wireless network. The gateway management resource of the first wireless network then distributes the location of the mobile communication device to a remote entity.

Yet further embodiments herein include, via the communication management hardware: triggering execution of location measurements by the second wireless network, the location measurements based on communications from the second wireless network to the mobile communication device; receiving the location measurements from the second wireless network; and utilizing the location measurements to determine the location of the mobile communication device.

As further discussed herein, the first wireless network can be configured to implement a first location management function. The second wireless network can be configured to implement a second location management function (such as so-called pseudo location management function). In one embodiment, the first location management function in the first wireless network is further operative to receive the location information from the second location management function disposed in the second wireless network. In such an instance, the second location management function generates the location information indicating the location of the mobile communication device based on wireless communications from multiple wireless base stations in the second wireless network to the mobile communication device. The first location management function controls generation and collection of the timing information. However, via communications from the second location management function to the first location management function, the second location management function collects the location information without control from the first wireless network. In one embodiment, the first wireless network and/or second wireless network establish connectivity such as an NL7 inter-network link between the first wireless network and the second wireless network. The first wireless network receives the location information from the second wireless network over the inter-link connectivity.

In still further example embodiments, via first subscriber identity module information assigned to the mobile communication device, the first wireless network provides voice wireless services to the mobile communication device. Via second subscriber identity module information assigned to the mobile communication device, the second wireless network provides non-voice (i.e., so-called data) wireless services to the mobile communication device. Via the first wireless access and first subscriber identity module information, the first wireless network provides notification of one or more call alerts from one or more wireless base station in the first wireless network to the mobile communication device. The first wireless network can be configured to control operations of the wireless base stations in the first wireless network to generate/collect timing information to determine the location of the mobile communication device based on such information. The collection of information from the second wireless network provides the location management function in the first wireless network with supplemental information to more accurately determine a location of the mobile communication device in the network environment. Additionally, or alternatively, note that the location management function in the first wireless network can be configured to determine the location of the mobile communication device based on only the timing information collected from the second wireless network.

In still further example embodiments, the communication management hardware as discussed herein detects a network address of a communication management resource disposed in the second wireless network; via communications to the communication management resource in the second wireless network, the communication management hardware controls operation of wireless base stations in the second wireless network to generate the location information (such as location measurement information). In one embodiment, the location information includes timing information associated with communications between the mobile communication device and the wireless base stations.

As previously discussed, the first wireless network (and one or more first wireless base stations) can be configured to provide first wireless access services to the mobile communication device while the second wireless network (and one or more second wireless base stations) can be configured to provide second wireless access services to the mobile communication device. One or more wireless base stations in the second wireless provide the second wireless access to the mobile communication device while the mobile communication device is disposed at the location.

Embodiments herein provide one or more novel ways of implementing location management functionality in a multi-network environment. For example, a location management function in a first wireless network can be configured to provide location management functionality to a second wireless network.

Note that any of the resources as discussed herein can include one or more computerized devices, wireless stations, mobile communication devices, servers, base stations, wireless communication equipment, communication management systems, controllers, workstations, user equipment, handheld or laptop computers, or the like to carry out and/or support any or all of the method operations disclosed herein. In other words, one or more computerized devices or processors can be programmed and/or configured to operate as explained herein to carry out the different embodiments as described herein.

Yet other embodiments herein include software programs to perform the steps and operations summarized above and disclosed in detail below. One such embodiment comprises a computer program product including a non-transitory computer-readable storage medium (i.e., any computer readable hardware storage medium) on which software instructions are encoded for subsequent execution. The instructions, when executed in a computerized device (hardware) having a processor, program and/or cause the processor (hardware) to perform the operations disclosed herein. Such arrangements are typically provided as software, code, instructions, and/or other data (e.g., data structures) arranged or encoded on a non-transitory computer readable storage medium such as an optical medium (e.g., CD-ROM), floppy disk, hard disk, memory stick, memory device, etc., or other a medium such as firmware in one or more ROM, RAM, PROM, etc., or as an Application Specific Integrated Circuit (ASIC), etc. The software or firmware or other such configurations can be installed onto a computerized device to cause the computerized device to perform the techniques explained herein. Accordingly, embodiments herein are directed to a method, system, computer program product, etc., that supports operations as discussed herein.

One embodiment includes a computer readable storage medium and/or system having instructions stored thereon to facilitate phase noise (pre) compensation (adjustment). The instructions, when executed by computer processor hardware, cause the computer processor hardware (such as one or more co-located or disparately processor devices) to: provide a mobile communication device first wireless access via a first wireless network in accordance with first subscriber identity information; detect that the mobile communication device has second wireless access to a second wireless network in accordance with second subscriber identity information; and implement a location management function in the first wireless network to monitor a location of the mobile communication device based on location information received from the second wireless network.

The ordering of the steps above has been added for clarity sake. Note that any of the processing steps as discussed herein can be performed in any suitable order. Other embodiments of the present disclosure include software programs and/or respective hardware to perform any of the method embodiment steps and operations summarized above and disclosed in detail below.

It is to be understood that the system, method, apparatus, instructions on computer readable storage media, etc., as discussed herein also can be embodied strictly as a software program, firmware, as a hybrid of software, hardware and/or firmware, or as hardware alone such as within a processor (hardware or software), or within an operating system or a within a software application.

As discussed herein, techniques herein are well suited for use in the field of wireless technology supporting wireless communications. However, it should be noted that embodiments herein are not limited to use in such applications and that the techniques discussed herein are well suited for other applications as well.

Additionally, note that although each of the different features, techniques, configurations, etc., herein may be discussed in different places of this disclosure, it is intended, where suitable, that each of the concepts can optionally be executed independently of each other or in combination with each other. Accordingly, the one or more present inventions as described herein can be embodied and viewed in many ways.

Also, note that this preliminary discussion of embodiments herein (BRIEF DESCRIPTION OF EMBODIMENTS) purposefully does not specify every embodiment and/or incrementally novel aspect of the present disclosure or claimed invention(s). Instead, this brief description only presents general embodiments and corresponding points of novelty over conventional techniques. For additional details and/or possible perspectives (permutations) of the invention(s), the reader is directed to the Detailed Description section (which is a summary of embodiments) and corresponding figures of the present disclosure as further discussed below.

### BRIEF DESCRIPTION OF THE DRAWINGS

FIG. 1 is an example diagram illustrating a wireless network environment and implementation of a remote communication management resource to provide location management functions according to embodiments herein.

FIG. 2 is an example diagram illustrating connectivity between a first wireless network and a second wireless network to support location management functionality according to embodiments herein.

FIG. 3 is an example diagram illustrating generation/collection of location measurement information and communication of same from a second wireless network over network connectivity to a first wireless network according to embodiments herein.

FIG. 4 is an example diagram illustrating i) conversion of the location measurement timing information into location information, ii) communication of the generated location information over a first communication link to the second wireless network, iii) communication of the location measurement information from the second wireless network over a second communication link to the first wireless network, and iv) distribution of the location information from the first wireless network according to embodiments herein.

FIG. 5 is an example diagram illustrating implementation of a controller communication management resource in communication with a pseudo-location management function in a second wireless network according to embodiments herein.

FIG. 6 is an example diagram illustrating i) communication of location measurement information from a second wireless network to a first wireless network, ii) conversion of the location measurement information into location information, and iii) distribution of the location information from a first wireless network according to embodiments herein.

FIG. 7 is an example diagram illustrating example computer architecture operable to execute one or more operations according to embodiments herein.

FIG. 8 is an example diagram illustrating a method according to embodiments herein.

The foregoing and other objects, features, and advantages of the invention will be apparent from the following more particular description of preferred embodiments herein, as illustrated in the accompanying drawings in which like reference characters refer to the same parts throughout the different views. The drawings are not necessarily to scale, with emphasis instead being placed upon illustrating the embodiments, principles, concepts, etc.

### DETAILED DESCRIPTION

According to one configuration, a multi-wireless communication system includes communication management hardware disposed in a first wireless network. The communication management hardware provides a mobile communication device first wireless access via a first wireless network in accordance with first subscriber identity information. The communication management hardware detects that the mobile communication device has second wireless access (corresponding user of the mobile communication device subscribes to) to a second wireless network in accordance with second subscriber identity information. To determine a location of the mobile communication device, the communication management hardware implements a location management function in the first wireless network. The location management function can be configured to communicate with one or more entities in the second wireless network to produce location measurement timing information associated with wireless communication between the second wireless network and the mobile communication device. The communication management hardware receives the location measurement timing information to generate location information indicating a location of the mobile communication device.

Thus, a second wireless network may not have an ability to generate location information indicating a location of a mobile communication device. For example, the second wireless network may not have a location management function. Via a location management function in the first wireless network, the controlled operation of the one or more wireless base stations in the second wireless network and corresponding generated timing information (such as times it takes for wireless signals to travel from the mobile communication device and the one or more wireless base stations in the second wireless network or vice-versa) enables the first wireless network to monitor the location of the mobile communication device via resources in the second wireless network.

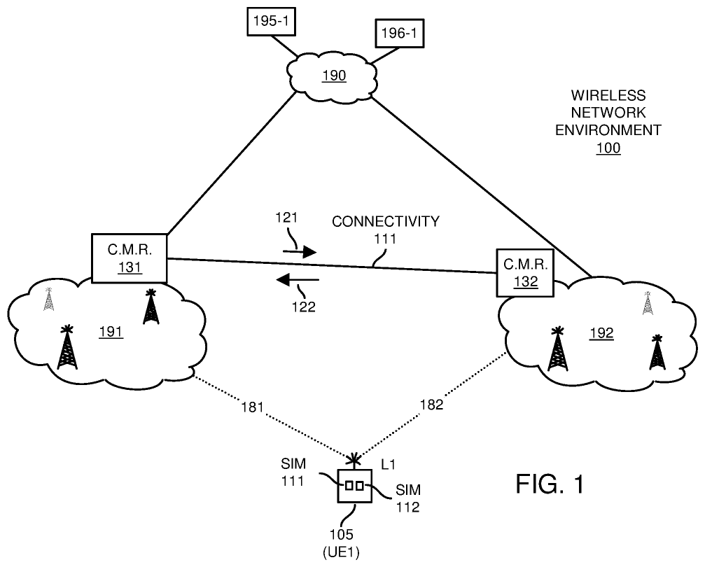

Now, more specifically, FIG. 1 is an example diagram illustrating a multi-wireless network environment and implementation of a remote communication management resource according to embodiments herein.

In this example embodiment, the wireless network environment 100 includes first wireless network 191 controlled and/or managed at least in part by communication management resource 131 (operator or service provider A) and second wireless network 192 controlled and/or managed at least in part by communication management resource 132 (operator or service provider B).

The wireless network 191 includes one or more wireless base stations to provide wireless connectivity 181 of mobile communication device 105 (a.k.a., user equipment UE1) to the network 190. Thus, the first wireless network 191 provides the mobile communication device 105 access to the remote network 190 and corresponding entities such as server entities 195, other mobile communication devices 196, etc.

The wireless network 192 includes one or more wireless base stations to provide wireless connectivity 182 of mobile communication device 105 (a.k.a., user equipment UE1) to the network 190. Thus, the wireless network 192 provides the mobile communication device 105 access to the remote network 190 and corresponding entities such as server entities 195, other mobile communication devices 196, etc.

In one embodiment, the wireless network 191 and corresponding wireless communication link 181 supports voice communications between the mobile communication device 105 and the wireless network 191. The mobile communication device 105 is configured with subscriber identity module information 111 to support the wireless connectivity 181 (and voice communications) with the wireless network 191.

In further example embodiments, the wireless communication link 182 supports non-voice communications (i.e., data communications, data sessions, etc.) between the mobile communication device 105 and the wireless network 192. The mobile communication device 105 is configured with subscriber identity module information 112 to support the wireless connectivity (and non-voice communications) with the wireless network 192.

Note that any of the resources as discussed herein can be implemented via hardware (circuitry), software, or a combination of hardware and software. For example, any or all of the functionality (functional blocks, modules, etc.) associated with the communication management resource 131 can be configured as communication management hardware, communication management software, or a combination of communication management hardware and communication management software; any or all of the functionality (functional blocks, modules, etc.) associated with the communication management resource 132 can be configured as communication management hardware, communication management software, or a combination of communication management hardware and communication management software; any or all of the functionality associated with the mobile communication device 105 can be configured as mobile communication device management hardware, mobile communication device management software, or a combination of mobile communication device management hardware and mobile communication device management software; and so on.

As further discussed herein, the communication management resource 132 and/or corresponding wireless network 192 may not include a so-called location management function that is configured to support determination of a location of the mobile communication device 105. As further discussed herein, the communication management resource 131 can be configured to implement one or more location management functions and control of resources in the second wireless network to determine a location of the mobile communication device 105 in the network environment 100 based on use of those resources such as generation and collection of location measurement timing information.

More specifically, as previously discussed, the multi-wireless network communication system (network environment 100) as discussed herein includes communication management resource 131 disposed in or associated with the first wireless network 191. The communication management resource provides the mobile communication device 105 first wireless access (such as voice connectivity) via a first wireless network 191 in accordance with first subscriber identity information 111.

In one embodiment, the communication management resource 131 detects that the mobile communication device 132 is afforded second wireless access to a second wireless network 192 in accordance with second subscriber identity information 192. In other words, the communication management resource 131 detects that the mobile communication device 105 is a dual subscriber identity module device including subscriber identity module 111 and subscriber identity module 112, meaning that the mobile communication device 105 has access to two different networks.

In still further example embodiments, via first subscriber identity module information 111 assigned to the mobile communication device 105, the first wireless network 191 provides voice wireless services to the mobile communication device 105. Via second subscriber identity module information 112 assigned to the mobile communication device 105, the second wireless network 192 provides non-voice wireless services (i.e., so-called data services) to the mobile communication device 105. Via the first wireless access and first subscriber identity module information, the first wireless network 191 provides notification of one or more call alerts from one or more wireless base station in the first wireless network to the mobile communication device. The call alerts indicate when another mobile communication device is calling the mobile communication device 105 and trying to establish a voice link connection.

As previously discussed, embodiments herein provide augmented location management of one or more mobile communication devices in a network environment 100. For example, to determine a current location L1 of the mobile communication device 105, the communication management resource 131 implements/controls location management functionality in the first wireless network 191 to manage collection of position/location information of the mobile communication device 105.

Note that the location management function in the communication management resource 131 can be configured to initiate execution of different location measurement information collection from the wireless network 192 to determine the current location L1 of the mobile communication device 105.

Via communications 121 from the communication management resource 131 over the connectivity 111 to the communication management resource 132, the communication management resource 131 controls the communication management resource 132 to produce location information (such as location measurement information). In one embodiment, the location measurement information generated by the communication management resource 132 and corresponding one or more wireless base station in wireless network 192 includes timing information associated with wireless communications between one or more wireless base stations in the second wireless network 192 and the mobile communication device 105.

The communication management resource 131 receives the location measurement information (timing information) via communications 122 over connectivity 111. As further discussed herein, the communication management resource 132 then uses the received location measurement information from the wireless network 192 to generate location information indicating the current location L1 of the mobile communication device 105. This process of collecting the location measurement information can be performed at different times to track a location of the mobile communication device 105 as it moves about the network environment 100.

As previously discussed, the first wireless network 191 (and one or more first wireless base stations) can be configured to provide first wireless access services to the mobile communication device 105 at the same time that the second wireless network (and one or more second wireless base stations) provides second wireless access services to the mobile communication device 105. Such services may be provided at different times as well. As further discussed herein, the one or more wireless base stations in the second wireless network 192 provide the second wireless access to the mobile communication device 105 while the mobile communication device is disposed at the location L1.

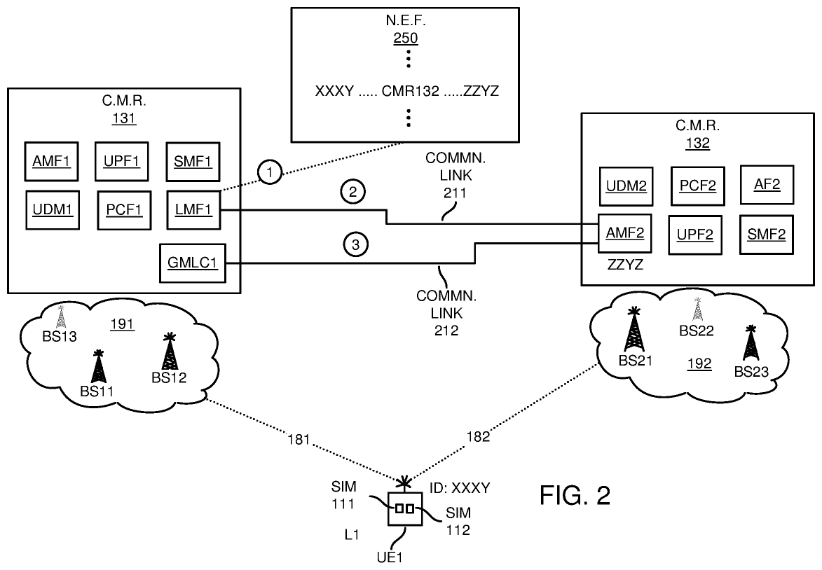

FIG. 2 is an example diagram illustrating connectivity between a first wireless network and a second wireless network to support location management functionality according to embodiments herein.

As previously discussed, the first wireless network 191 (and one or more first wireless base stations) can be configured to provide first wireless access services to the mobile communication device 105 at the same time that the second wireless network (and one or more second wireless base stations) provides second wireless access services to the mobile communication device 105. Note also that either wireless network may be idle while the other wireless network provides wireless services. For example, the wireless link 181 may be idle (such as not used to convey voice communications) while the wireless link 182 is used by the mobile communication device 182 to transmit and receive non-voice communications (data).

As further discussed herein, the one or more wireless base stations in the second wireless 192 provide the second wireless access to the mobile communication device 105 while the mobile communication device is disposed at the location L1.

In this example embodiment, during operation #1, the location management function LMF1 (communication management resource function) of the communication management resource 131 detects that the mobile communication device 105 is a dual or multi SIM device in which the mobile communication device is afforded wireless access to communicate with network 190 via and/or through the wireless network 192. In such an instance, to implement augmented location monitoring as discussed herein, the location management function LMF1 of the communication management resource 131 accesses a server resource such as a so-called network exposure function 250 (a.k.a., NEF) to determine a network address ZZYZ of a communication management resource (such as an AMF or Access and Mobility Management Function) in the second wireless network 192.

More specifically, in response to detecting that the mobile communication device is a dual subscriber identity module device, and to implement augmented location management functionality, the communication management resource 131 provides the network exposure function 250 the identity XXXY (such as network address or other suitable value) assigned to the mobile communication device 105. The network exposure function 250 maps the identity XXXY of the mobile communication device 105 to the communication management resource 132 and corresponding communication management resource AMF2 having assigned network address of ZZYZ. This mapping allows the location management function LMF1 of the communication management resource 131 to communicate directly with the communication management resource AMF2 via established communication link 211. As previously discussed, the communication management resource AMF2 (Access and Mobility Management Function) has the ability to control operations of resources such as one or more wireless base stations (BS21, BS22, BS23, etc.) in the second wireless network 192 to collect/generate location measurement timing information used to determine a location L1 of the mobile communication device 105.

As further shown, in processing operation #2, based on receiving the network address ZZYZ of the communication management resource AMF2, the location management function LMF1 of the communication management resource 131 establishes a communication link 211 between the first wireless network 191 and the second wireless network 192 via an inter-network communication link 211. In one embodiment, the inter-network communication link 211 is as an NL1 inter-network link.

In addition to establishing the communication link 211, the communication management resource 131 and/or communication management resource 132 establish the communication link 212 (processing operation #3) such as an inter-network link NL2 or other suitable entity between the communication management resource GMLC1 and the communication management resource AMF2.

Thus, embodiments herein include the communication management resource 131 detecting a network address ZZYZ of a communication management resource AMF2 disposed in the second wireless network 192; via communications to the communication management resource AMF2 (or other suitable entity) in the second wireless network 192 over the communication link 211, the communication management resource LMF1 controls operation of one or more resources in the wireless network 192 such as wireless base stations BS21, BS22, BS23, etc., in the second wireless network 192 to generate the location timing information indicating the location of the mobile communication device 105. As further discussed herein, the location timing information may include timing information associated with communications between the mobile communication device and the wireless base stations.

In addition to establishing communication link 211, embodiments herein further include establishing the communication link 212 between the communication management resource GMLC1 and the communication management resource AMF2. As further discussed herein, the communication link 212 can be used to convey data between the communication management resource GMLC1 and the communication management resource AMF2.

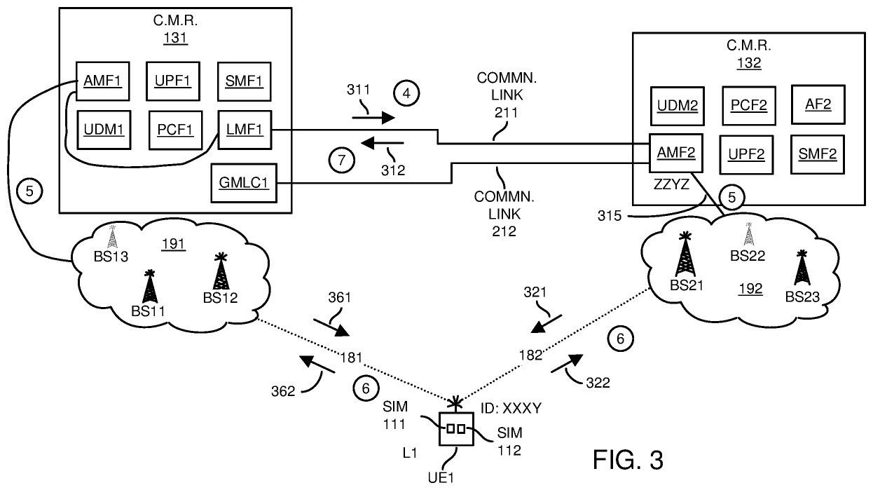

FIG. 3 is an example diagram illustrating generation/collection of location measurement information and communication of same from a second wireless network over network connectivity to a first wireless network according to embodiments herein.

In this example embodiment, the communication management resource 131 implements the location management function LMF1 in the first wireless network to monitor the location L1 of the mobile communication device 105 based on location information received from one or more resources (such as wireless base stations) of the second wireless network and/or location information received from the first wireless network 191. In one embodiment, in processing operation #4, via communications 311 to the communication management resource AMF2, the location management function LMF1 in the wireless network 191 controls multiple wireless base stations BS21, BS22, BS23, etc., in the second wireless network 192 communicating with the mobile communication device 105. In one embodiment, the communication management resource AMF2 controls the wireless base stations in wireless network based on input from the location management function LMF1.

Additionally, via input from the communication management resource AMF1, note that the first wireless network 191 and corresponding location management function LMF1 can be configured to control operations of the wireless base stations BS11, BS12, BS13, etc., in the first wireless network 191 to generate/collect location measurement timing information to determine the location of the mobile communication device 105 based on such information as well. Thus, the first wireless network and corresponding wireless base stations can be used to determine a location of the mobile communication device 105.

In accordance with further example embodiments, the collection of position/location information from the second wireless network 192 provides the location management function LMF1 in the first wireless network with supplemental information to more accurately determine a location of the mobile communication device 105 in the network environment 100. For example, the communication management resource LMF1 can be configured to control wireless base stations in the first wireless network 191 and/or wireless base stations in the second wireless network 192 to generate location measurement timing information used to determine location L1.

Additionally, or alternatively, note that the location management function LMF1 in the first wireless network 191 can be configured to determine the location L1 of the mobile communication device 105 based on only the location measurement timing information (i.e., travel times of wireless communications 321 from each of the wireless base stations BS21, BS22, BS23, etc., to the mobile communication device 105 and/or travel times of wireless communications 322 from the mobile communication device 105 to each of the wireless base stations BS21, BS22, BS23, etc.) collected from communications 321 and/or communications 322 (in processing operation #6) communicated between the wireless base stations BS21, BS22, BS23, etc., and the mobile communication device 105. The location management function LMF1 in the first wireless network 191 can be configured to determine the location L1 of the mobile communication device 105 also based on the location measurement timing information (i.e., travel times of wireless communications 361 from each of the wireless base stations BS11, BS12, BS13, etc., to the mobile communication device 105 and/or travel times of wireless communications 362 from the mobile communication device 105 to each of the wireless base stations BS11, BS12, BS13, etc.) collected and associated with communications 361 and/or communications 362 communicated between the wireless base stations BS11, BS12, BS13, etc., and the mobile communication device 105 over the communication link 181 in processing operation #6.

The wireless base stations or other suitable one or more entities generate, for each wireless base station, timing information that tracks a time it takes a respective wireless signal to travel from the respective wireless base station to the mobile communication device or the time it takes a respective wireless signal to travel from the mobile communication device to each of the respective wireless base stations in wireless network 192.

In processing operation #4, via communications 311, the location management function LMF1 notifies the communication management resource AMF2 to implement timing tests as previously discussed in the wireless network 192.

In processing operation #5, via communications 315, the communication management resource AMF2 causes the mobile communication device 105 and the wireless base stations in the network 192 to implement location testing. More specifically, in processing operation #6, the one or more wireless base stations transmit communications through 21 to the communication device 105; the communication device 105 transmits wireless communications 322 to the wireless base stations in network 192. The communication management resource AMF2 or other suitable entity determines travel times of communicating between the mobile communication device and each of the wireless base stations. The information generated during this process is known as location measurement timing information or generally timing information.

The communication management hardware receives the timing information and implements so-called trilateration or other techniques (e.g., based on location measurement timing information including one or more of the following: i) wireless signal travel time between wireless base station BS21 transmitting a wireless signal and the mobile communication device 105 receiving the signal, ii) wireless signal travel time between wireless base station BS22 transmitting a wireless signal and the mobile communication device 105 receiving the signal, iii) wireless signal travel time between wireless base station BS23 transmitting a wireless signal and the mobile communication device 105 receiving the signal, . . . , i) wireless signal travel time between the mobile communication device 105 transmitting a wireless signal and the wireless base station BS21 receiving the signal, ii) wireless signal travel time between the mobile communication device 105 transmitting a wireless signal and the wireless base station BS22 receiving the signal, iii) wireless signal travel time between the mobile communication device 105 transmitting a wireless signal and the wireless base station BS23 receiving the signal, and so on) to determine the location L1 of the mobile communication device 105. Thus, in one embodiment, the location information from the second wireless network 192 includes location measurements (such as timing information) obtained from a communication management resource AMF2 implementing location testing in the second network 192. The travel times of signals 321 and/or 322 can be converted to distance measurements used to determine the location L1 with respect to the known locations of the wireless base stations BS21, BS22, BS23, etc.

Accordingly, embodiments herein include the communication management resource 131 such as location management function LMF1 in or associated with the wireless network 191 to trigger execution of location measurements (wireless signal travel time measurement in operation #5 and operation #6) by the second wireless network 192; the location measurements are based on communications (321 and/or 322) from the wireless base stations in wireless network 192 and/or the mobile communication device 105. The communication management resource 131 in the wireless network 191 receives the location measurements (location measurement information or timing information generated in processing operation 5 and 6) from the second wireless network 192 and utilizes the location measurements to determine the location L1 of the mobile communication device 105.

In one embodiment, in processing operation #7, and via communications 312 after collecting location measurement timing information, the communication management resource AMF2 communicates the location measurement timing information (timing information as generated in the processing operations 5 and 6) from the communication management resource AMF2 over communication link 212 to the location management function LMF1.

In summary, the wireless network environment 100 (such as a 5G network environment or other suitable entity) supports wireless communications in accordance with the 5G wireless communication protocols or other suitable wireless communication protocols. The location management function LMF1 (such as a network entity disposed in the communication management resource 131 such as Core Network of wireless network 191 to provide positioning functionality) determines the geographic position (that is, location L1) of the mobile communication device 105 based on downlink (communications 321) and uplink location measuring radio signals (communications 322). In other words, the location management function LMF1 receives measurements and assistance information from the operations of wireless base stations in wireless network 192 and the mobile communication device 105, otherwise known as the user equipment (UE), via or through the access and mobility management function (AMF2) over the communication link 211. The location management function LMF1 and/or other entity in the communication management resource 131 computes the position (location) of the mobile communication device 105.

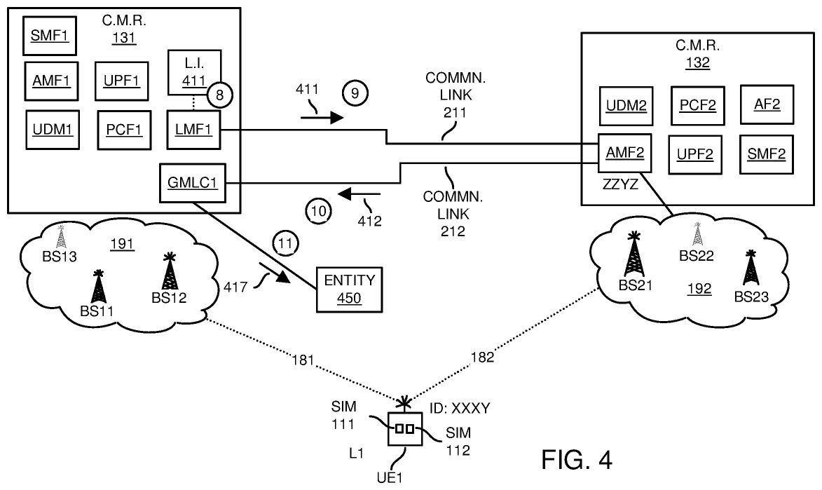

FIG. 4 is an example diagram illustrating i) conversion of the location measurement information into location information at the first wireless network, ii) communication of the generated location information over a first communication link to the second wireless network, iii) communication of the location measurement information back from the second wireless network over a second communication link to the first wireless network, and iv) distribution of the location information from the first wireless network according to embodiments herein.

More specifically, as previously discussed, the location management function LMF1 of the communication management resource 131 receives the location measurement timing information generated by the second wireless network 192. In processing operation #8, the location management function LMF1 utilizes the received location measurement information (such as raw timing information) to derive location information indicating a location L1 of the mobile communication device 105.

In processing operation #9, the communication management resource LMF1 can be configured to communicate the resulting location information indicating the location L1 of the mobile communication device 105 in communications 411 over the communication link 211 to the communication management resource AMF2. In processing operation #10, the communication management resource AMF2 communicates the generated location information over the communication link 212 (such as second inter-network link) to a gateway management resource GMLC1 of the first wireless network 191. In processing operation #11, the gateway management resource GMLC1 then distributes the location L1 of the mobile communication device 105 to one or more remote entities such as entity 450.

Additionally, or alternatively, note that the location management function LMF1 can be configured to communicate the information to the communication management resource AMF1, and communication management resource AMF1 forwards the information to the distribution gateway GMLC1.

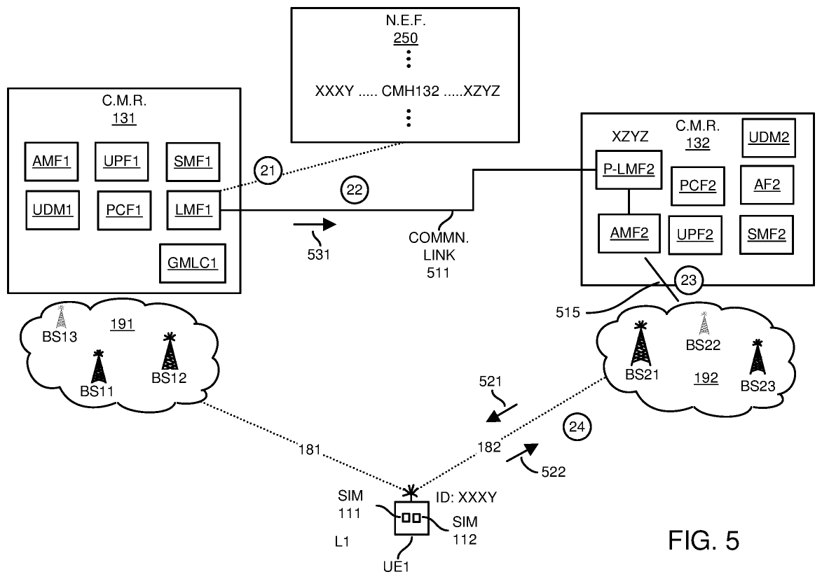

FIG. 5 is an example diagram illustrating implementation of a controller communication management resource in communication with a pseudo-location management function in a second wireless network according to embodiments herein.

As further discussed herein, the first wireless network 191 can be configured to implement a first location management function LMF1 in a similar manner as previously discussed. The second wireless network 191 can be configured to implement a second location management function (such as so-called pseudo location management function P-LMF2). Such an embodiment (implementation of location management function P-LMF2) is useful in cases where the second wireless network service provider B operating (controlling) the second wireless network 192 does not want to give the first wireless network service provider A operating the first wireless network 191 access to the communication management resource AMF2 of wireless network 192.

As an example, in processing operation #21, the communication management resource 131 provides the network exposure function 250 the identity XXXY of the communication device 105. The network exposure function 250 maps the identity XXXY of the mobile communication device 105 to XZYZ (such as network address) of the location management function P-LMF2 in the wireless network 192. The network exposure function 250 notifies the location management function LMF1 of the communication management resource 131 of the network address XZYZ of the location management function P-LMF2 in which to establish communication link 511 to support location management functionality as discussed herein.

The communication management resource 131 and the communication management resource 132 establish communication link 511 (such as an NL7 inter-network link) between the first wireless network 191 and the second wireless network 192.

In processing operation #22, via communications 531, the location management function LMF1 of the communication management resource 131 notifies the location management function P-LMF2 to implement location measurements via operation of wireless base stations BS21, BS22, BS23, etc., in a similar manner as previously discussed. Additionally, or alternatively, note that the location management function P-LMF2 can be configured to collect location measurement information associated with the location of the mobile communication device 105 without the location management function P-LMF2 receiving a command via communications 531 from the location management function LMF1. In other words, the location management function P-LMF2 may itself initiate collection of the location measurement timing information via communications with the communication management resource AMF2.

As further shown, in processing operation #23, the location management function P-LMF2 communicates with the communication management resource AMF2 to implement location measurements via operation of wireless base stations BS21, BS22, BS23, etc., in a similar manner as previously discussed. More specifically, in processing operation #23, via communications 515, the communication management resource AMF2 controls the wireless network 192 and corresponding wireless base stations BS21, BS22, BS23, etc., to implement location measurements (collecting travel time information in a manner as previously discussed). See details of generating the location measurement information (obtaining wireless communication travel time information) in processing operation #24, which is similar to collecting signal travel time as previously time in a manner as previously discussed but using wireless communications 521 and wireless communications 522.

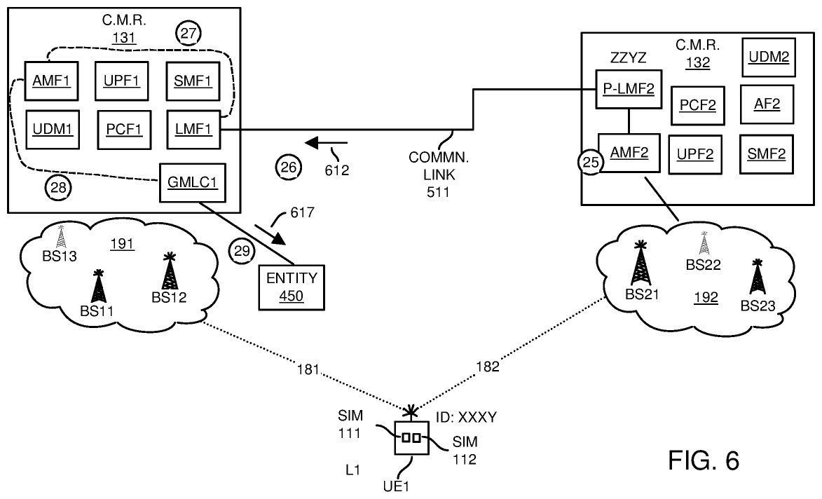

FIG. 6 is an example diagram illustrating i) communication of location measurement information from a second wireless network to a first wireless network, ii) conversion of the location measurement information into location information, and iii) distribution of the location information from a first wireless network according to embodiments herein.

In processing operation #25, the communication management resource AMF2 collects and communicates the location measurement timing information to the location management function P-LMF2 in the communication management resource 132.

In processing operation #26, via communications 612 over the communication link 511, the location management function P-LMF2 communicates the collected location measurement information to the location management function LMF1 in the communication management resource 131.

Thus, via communications 612, the first location management function LMF1 in the communication management resource 131 of wireless network 191 is further operative to receive the location information (i.e., raw signal travel measurement information associated with communications 521 and communications 522) from the second location management function P-LMF2 (a.k.a., pseudo location management function) disposed in or associated with the second wireless network 192.

In such an instance, the location management function P-LMF2 and/or communication management resource AMF2 generates and/or converts the location measurement information indicating distance between entities. Based on such determined distance information, the location management function LMF1 or other suitable entity determines the location of the mobile communication device 105. As previously discussed, the first location management function LMF1 and/or location management function P-LMF2 can be configured to control generation and collection of the timing information (location measurement information). More specifically, the second location management function P-LMF2 can be configured to collect the location measurement information (signal travel time information) with or without control from the first wireless network 191 and/or location management function LMF1.

Further, in processing operation #26, the location management function LMF1 or other suitable entity receiving the raw location measurement information (wireless signal travel time information) converts the raw location measurement information into corresponding location information indicating the location L1 of the mobile communication device 105.

In processing operation #27, the location management function LMF1 forwards the location information L1 to the communication management resource AMF1.

In processing operation #28, the communication management resource AMF1 communicates the generated location information L1 to the gateway management resource GMLC1 of the first wireless network 191.

In processing operation #29, the gateway management resource GMLC1 then distributes the location L1 (based on location measurement information generated by wireless network 192) of the mobile communication device 105 to one or more remote entities such as entity 450.

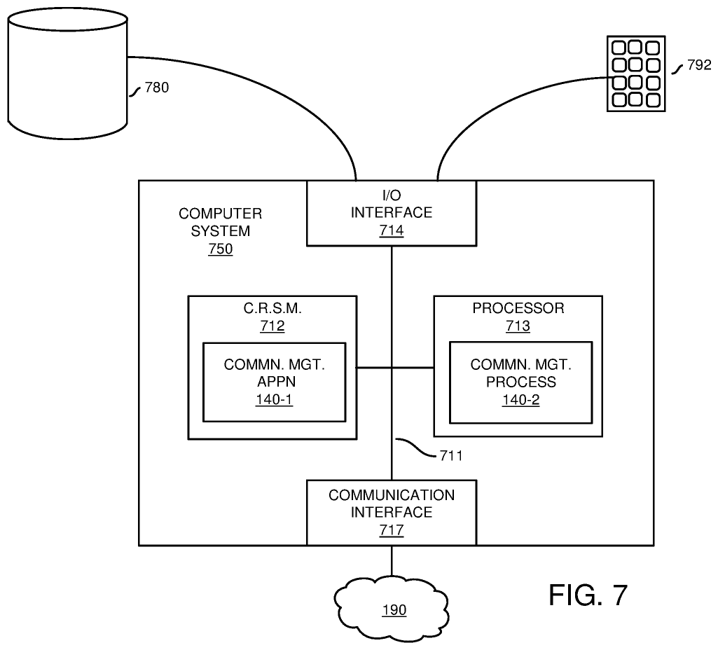

FIG. 7 is an example block diagram of a computer system for implementing any of the operations as previously discussed according to embodiments herein.

Any of the resources (such as wireless stations, communication management resource 131, communication management resource 132, mobile communication device 105, user equipment UE1, location management function LMF1, communication management resource AMF2, location management function P-LMF2, etc.) as discussed herein can be configured to include computer processor hardware and/or corresponding executable instructions to carry out the different operations as discussed herein.

As shown, computer system 750 of the present example includes interconnect 711 coupling computer readable storage media 712 such as a non-transitory type of media (which can be any suitable type of hardware storage medium in which digital information can be stored and or retrieved), a processor 713 (computer processor hardware), I/O interface 714, and a communications interface 717.

I/O interface(s) 714 supports connectivity to repository 780 and input resource 792.

Computer readable storage medium 712 can be any hardware storage device such as memory, optical storage, hard drive, floppy disk, etc. In one embodiment, the computer readable storage medium 712 stores instructions and/or data.

As shown, computer readable storage media 712 can be encoded with communication management application 140-1 (e.g., including instructions) in a respective wireless station to carry out any of the operations as discussed herein.

During operation of one embodiment, processor 713 accesses computer readable storage media 712 via the use of interconnect 711 in order to launch, run, execute, interpret or otherwise perform the instructions in communication management application 140-1 stored on computer readable storage medium 712. Execution of the communication management application 140-1 produces communication management process 140-2 to carry out any of the operations and/or processes as discussed herein.

Those skilled in the art will understand that the computer system 750 can include other processes and/or software and hardware components, such as an operating system that controls allocation and use of hardware resources to execute communication management application 140-1.

In accordance with different embodiments, note that computer system may reside in any of various types of devices, including, but not limited to, a mobile computer, a personal computer system, a wireless device, a wireless access point, a base station, phone device, desktop computer, laptop, notebook, netbook computer, mainframe computer system, handheld computer, workstation, network computer, application server, storage device, a consumer electronics device such as a camera, camcorder, set top box, mobile device, video game console, handheld video game device, a peripheral device such as a switch, modem, router, set-top box, content management device, handheld remote control device, any type of computing or electronic device, etc. The computer system 750 may reside at any location or can be included in any suitable resource in any network environment to implement functionality as discussed herein.

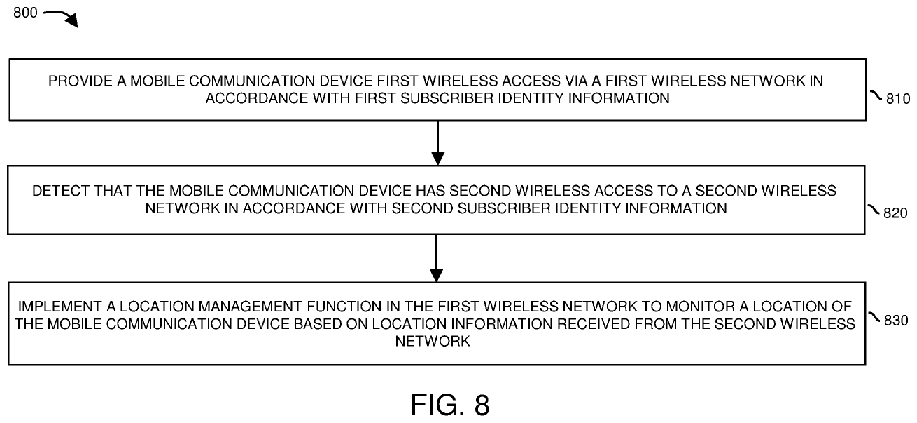

Functionality supported by the different resources will now be discussed via flowcharts in FIG. 8. Note that the steps in the flowcharts below can be executed in any suitable order.

FIG. 8 is a flowchart 800 illustrating an example method according to embodiments herein. Note that there will be some overlap with respect to concepts as discussed above.

In processing operation 810, the communication management resource 131 and corresponding wireless network 191 provide the mobile communication device 105 first wireless access via a first wireless network 191 in accordance with first subscriber identity information 111.

In processing operation 820, the communication management resource 131 detects that the mobile communication device 105 has second wireless access to a second wireless network 192 in accordance with second subscriber identity information 112.

In processing operation 830, the communication management resource 131 implements a location management function (such as LMF1) in the first wireless network 191 to monitor a location of the mobile communication device 105 based on location information (a location measurement information) received from the second wireless network 192 (such as AMF2 which is a communication management resource configured to control location measurement operations of wireless base stations in the wireless network 192).

Note again that techniques herein are well suited to facilitate use of a shared wireless channel amongst different types of wireless stations. However, it should be noted that embodiments herein are not limited to use in such applications and that the techniques discussed herein are well suited for other applications as well. Based on the description set forth herein, numerous specific details have been set forth to provide a thorough understanding of claimed subject matter. However, it will be understood by those skilled in the art that claimed subject matter may be practiced without these specific details. In other instances, methods, apparatuses, systems, etc., that would be known by one of ordinary skill have not been described in detail so as not to obscure claimed subject matter. Some portions of the detailed description have been presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm as described herein, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has been convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a computing platform, such as a computer or a similar electronic computing device, that manipulates or transforms data represented as physical electronic or magnetic quantities within memories, registers, or other information storage devices, transmission devices, or display devices of the computing platform.

While this invention has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting. Rather, any limitations to the invention are presented in the following claims.

1. A method comprising:
providing a mobile communication device first wireless access via a first wireless network in accordance with first subscriber identity information;
detecting that the mobile communication device has second wireless access to a second wireless network in accordance with second subscriber identity information; and
implementing a location management function in the first wireless network to monitor a location of the mobile communication device based on location information received from the second wireless network.

2. The method as in claim 1 further comprising:
implementing the location management function in the first wireless network to monitor the location of the mobile communication device based on a combination of the location information received from the second wireless network and supplemental location information received from the first wireless network.

3. The method as in claim 1, wherein the location information includes location measurements obtained from a communication management resource operating in the second network.

4. The method as in claim 1, wherein implementing the location management function includes establishing a communication link between the first wireless network and the second wireless network via an inter-network communication link.

5. The method as in claim 1, wherein the inter-network link is an NL1 inter-network link.

6. The method as in claim 1 further comprising:
establishing a first inter-network link between the first wireless network and the second wireless network;
establishing a second inter-network link between the first wireless network and the second wireless network; and
communicating location information from the first wireless network over the first inter-network link and the second inter-network link to a gateway management resource of the first wireless network, the gateway management resource operative to distribute the location of the mobile communication device to a remote entity.

7. The method as in claim 1, wherein implementing the location management function in the first wireless network to monitor the location of the mobile communication device includes:
triggering execution of location measurements by the second wireless network, the location measurements based on communications from the second wireless network to the mobile communication device;
receiving the location measurements from the second wireless network; and
utilizing the location measurements to determine the location of the mobile communication device.

8. The method as in claim 1, wherein the location management function is a first location management function, the method further comprising:
receiving the location information from a second location management function disposed in the second wireless network, the second location management function operative to generate the location information, the location information indicating the location of the mobile communication device based on wireless communications from multiple wireless base stations in the second wireless network to the mobile communication device.

9. The method as in claim 8, wherein the second location management function is operative to collect the location information without control from the first wireless network.

10. The method as in claim 8 further comprising:
receiving the location information from the second location management function over an NL7 inter-network link between the first wireless network and the second wireless network.

11. The method as in claim 1 further comprising:
via the first wireless access, providing notification of a call alert from a first wireless base station in the first wireless network to the mobile communication device.

12. The method as in claim 1, wherein implementing the location management function includes:
detecting a network address of a communication management resource disposed in the second wireless network; and
controlling operation of wireless base stations in the second wireless network to generate the location information.

13. The method as in claim 12, wherein the location information includes timing information associated with communications between the mobile communication device and the wireless base stations.

14. The method as in claim 1, wherein first wireless base stations in the first wireless provide the first wireless access to the mobile communication device while the mobile communication device is disposed at the location; and
wherein second wireless base stations in the second wireless provide the second wireless access to the mobile communication device while the mobile communication device is disposed at the location.

15. A system comprising:
communication management hardware operative to:
provide a mobile communication device first wireless access via a first wireless network in accordance with first subscriber identity information;
detect that the mobile communication device has second wireless access to a second wireless network in accordance with second subscriber identity information; and
implement a location management function in the first wireless network to monitor a location of the mobile communication device based on location information received from the second wireless network.

16. The system as in claim 15, wherein the communication management hardware is further operative to:
implement the location management function in the first wireless network to monitor the location of the mobile communication device based on a combination of the location information received from the second wireless network and supplemental location information received from the first wireless network.

17. The system as in claim 15, wherein the location information includes location measurements obtained from a communication management resource operating in the second network.

18. The system as in claim 15, wherein the communication management hardware is further operative to:
establish a communication link between the first wireless network and the second wireless network via an inter-network communication link.

19. The system as in claim 15, wherein the inter-network link is an NL1 inter-network link.

20. The system as in claim 15, wherein the communication management hardware is further operative to:
establish a first inter-network link between the first wireless network and the second wireless network;
establish a second inter-network link between the first wireless network and the second wireless network; and
communicate location information from the first wireless network over the first inter-network link and the second inter-network link to a gateway management resource of the first wireless network, the gateway management resource operative to distribute the location of the mobile communication device to a remote entity.

21. The system as in claim 15, wherein the communication management hardware is further operative to:
trigger execution of location measurements by the second wireless network, the location measurements based on communications from the second wireless network to the mobile communication device;
receive the location measurements from the second wireless network; and
utilize the location measurements to determine the location of the mobile communication device.

22. The system as in claim 15, wherein the location management function is a first location management function; and
wherein the communication management hardware is further operative to:
receive the location information from a second location management function disposed in the second wireless network, the second location management function operative to generate the location information, the location information indicating the location of the mobile communication device based on wireless communications from multiple wireless base stations in the second wireless network to the mobile communication device.

23. The system as in claim 22, wherein the second location management function is operative to collect the location information without control from the first wireless network.

24. The system as in claim 22, wherein the communication management hardware is further operative to:
receiving the location information from the second location management function over an NL7 inter-network link between the first wireless network and the second wireless network.

25. The system as in claim 15, wherein the communication management hardware is further operative to:
via the first wireless access, provide notification of a call alert from a first wireless base station in the first wireless network to the mobile communication device.

26. The system as in claim 15, wherein the communication management hardware is further operative to:
detect a network address of a communication management resource disposed in the second wireless network; and
control operation of wireless base stations in the second wireless network to generate the location information.

27. The system as in claim 26, wherein the location information includes timing information associated with communications between the mobile communication device and the wireless base stations.

28. The system as in claim 15, wherein first wireless base stations in the first wireless provide the first wireless access to the mobile communication device while the mobile communication device is disposed at the location; and
wherein second wireless base stations in the second wireless provide the second wireless access to the mobile communication device while the mobile communication device is disposed at the location.

29. Computer-readable storage hardware having instructions stored thereon, the instructions, when carried out by computer processor hardware, cause the computer processor hardware to:
provide a mobile communication device first wireless access via a first wireless network in accordance with first subscriber identity information;
detect that the mobile communication device has second wireless access to a second wireless network in accordance with second subscriber identity information; and
implement a location management function in the first wireless network to monitor a location of the mobile communication device based on location information received from the second wireless network.
